(19) United States
(12) Patent Application Publication
(10) Pub. No.: US 2025/0119030 A1
(43) Pub. Date: Apr. 10, 2025

(54) ELECTRIC MACHINE HAVING INTEGRATED INDUCTIVE POSITION SENSOR WITH NON-CONTACT POWER TRANSFER

(71) Applicant: GM GLOBAL TECHNOLOGY OPERATIONS LLC, Detroit, MI (US)

(72) Inventors: Mazharul Chowdhury, Canton, MI (US); Muhammad A. Zahid, Troy, MI (US); Khorshed Mohammed Alam, Canton, MI (US); Suresh Gopalakrishnan, Troy, MI (US); Ajay Mehta, Auburn Hills, MI (US); Chandra S. Namuduri, Troy, MI (US)

(73) Assignee: GM GLOBAL TECHNOLOGY OPERATIONS LLC, Detroit, MI (US)

(21) Appl. No.: 18/482,212

(22) Filed: Oct. 6, 2023

(51) Int. Cl. H02K 11/225; G01D 5/20; H02J 50/05; H02J 50/10; H02K 11/042

(52) U.S. Cl. CPC H02K 11/225; G01D 5/2053; H02K 11/042; H02J 50/05; H02J 50/10

(57) ABSTRACT

An electric machine includes a rotor assembly having a rotor shaft disposed along a central axis. The electric machine includes an inductive position sensor having a sensor target that is operatively connected to the rotor shaft. The sensor target is fixed relative to the rotor shaft such that the sensor target rotates with the rotor shaft. The electric machine includes a stationary member and a rotating member operatively connected to the rotor shaft. The rotating member is spaced from the stationary member by an air gap. The stationary member and the rotating member are configured to enable non-contact power transfer from the stationary member to the rotating member through the air gap. The non-contact power transfer may be an inductive power transfer or a capacitive power.

### INTRODUCTION

The disclosure relates to an electric machine having an integrated inductive position sensor with non-contact power transfer. An electric machine generally includes a stator having a plurality of stator windings and a rotor rotatable within the stator. In a generator mode, the rotation of the rotor induces voltage in the stator winding, which powers an external load. Alternately, if an electric current is passed through the stator windings, the energized windings cause the rotor to rotate, and the machine will perform as a motor. Separately excited electric machines generally employ a resolver to determine the position and speed of the rotor. Furthermore, an external device is generally required to transfer power to the rotor in a separately excited electric machine. Accommodating a resolver and an external power transfer device in an electric machine is a challenging issue.

### SUMMARY

Disclosed herein is an electric machine having a rotor assembly with a rotor shaft disposed along a central axis. The electric machine includes an inductive position sensor having a sensor target that is operatively connected to the rotor shaft. The sensor target is fixed relative to the rotor shaft such that the sensor target rotates with the rotor shaft. The electric machine includes a stationary member and a rotating member operatively connected to the rotor shaft. The rotating member is spaced from the stationary member by an air gap. The stationary member and the rotating member are configured to enable non-contact power transfer from the stationary member to the rotating member through the air gap.

The inductive position sensor may include an inductive sensor board adapted to detect motion of the sensor target. The inductive sensor board is stationary. The inductive sensor board includes a plurality of windings having transmitting coils and receiving coils. The receiving coils may include a positive first coil, a negative first coil, a positive second coil, and a negative second coil. The electric machine may include a rectifier circuit directly connected to the rotating member. The rotor assembly includes rotor windings electrically coupled with the rectifier circuit.

In one embodiment, the stationary member includes a stationary core embedded with a first set of coils, the rotating member including a rotating core embedded with a second set of coils, and the non-contact power transfer between the stationary member and the rotating member is an inductive power transfer. Here, the sensor target may be positioned directly on the rotor shaft along the central axis. Alternatively, the sensor target may be positioned circumferentially around the rotor shaft. In another example, the sensor target may be positioned circumferentially around the rotating core, the rotating core is positioned circumferentially around the rotor shaft, and the sensor target is etched on the rotating core.

In another embodiment, the stationary member and the rotating member respectively include a stationary plate and a rotating plate positioned sufficiently close together to form a capacitor, such that the non-contact power transfer between the stationary member and the rotating member is a capacitive power transfer. Here, the sensor target may be positioned directly on the rotor shaft along the central axis. Alternatively, the sensor target may be positioned circumferentially around the rotor shaft. In some embodiments, the sensor target is positioned circumferentially around the rotating plate, the rotating plate is positioned circumferentially around the rotor shaft, and the sensor target is etched on the rotating plate.

Disclosed herein is a vehicle having an electric machine with a rotor assembly having a rotor shaft disposed along a central axis. An inductive position sensor having a sensor target is operatively connected to the rotor shaft and an inductive sensor board adapted to detect motion of the sensor target. The sensor target is fixed relative to the rotor shaft such that the sensor target rotates with the rotor shaft. A stationary member is operatively connected to the rotor shaft, the stationary member including a stationary core embedded with a first set of coils. A rotating member is operatively connected to the rotor shaft, the rotating member being spaced from the stationary member by an air gap, the rotating member including a rotating core embedded with a second set of coils. The inductive sensor board is stationary and includes a plurality of windings having transmitting coils and receiving coils. The stationary member and the rotating member are configured to enable non-contact power transfer from the stationary member to the rotating member through the air gap.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic fragmentary block diagram of a vehicle having a propulsion system with an electric machine;

FIG. 2 is a schematic fragmentary sectional view through the electric machine of FIG. 1, in accordance with a first embodiment;

FIG. 3 is a schematic fragmentary sectional view through the electric machine of FIG. 1, in accordance with a second embodiment;

FIG. 4A is a schematic fragmentary sectional view through the electric machine of FIG. 1, in accordance with a third embodiment;

FIG. 4B is a schematic fragmentary side view of the electric machine of FIG. 4A;

FIG. 5 is a schematic fragmentary sectional view through the electric machine of FIG. 1, in accordance with a fourth embodiment;

FIG. 6 is a schematic fragmentary sectional view through the electric machine of FIG. 1, in accordance with a fifth embodiment;

FIG. 7 is a schematic fragmentary sectional view through the electric machine of FIG. 1, in accordance with a sixth embodiment;

FIG. 8 is a schematic fragmentary diagram of an example position sensor employable in the electric machine of FIG. 1; and

FIG. 9 is a schematic perspective view of a portion of the position sensor of FIG. 8.

Representative embodiments of this disclosure are shown by way of non-limiting example in the drawings and are described in additional detail below. It should be understood, however, that the novel aspects of this disclosure are not limited to the particular forms illustrated in the above-enumerated drawings. Rather, the disclosure is to cover modifications, equivalents, combinations, sub-combinations, permutations, groupings, and alternatives falling within the scope of this disclosure as encompassed, for instance, by the appended claims.

### DETAILED DESCRIPTION

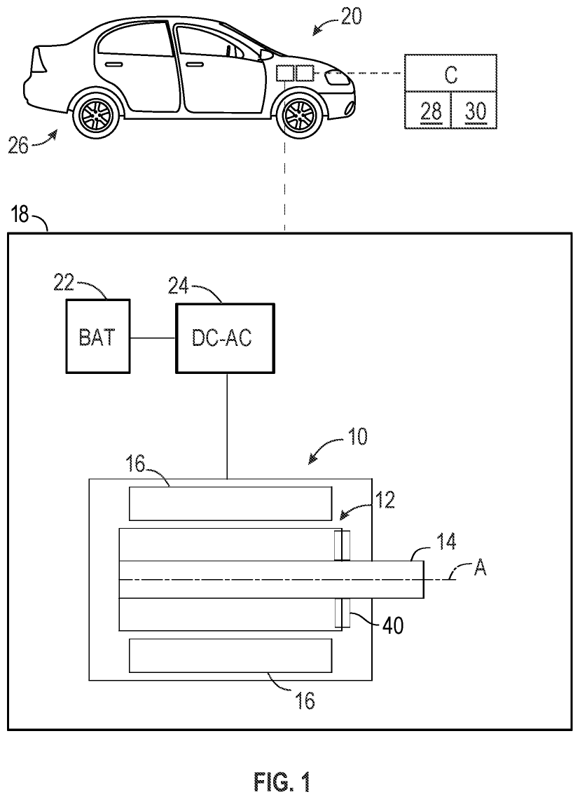

Referring to the drawings, wherein like reference numbers refer to like components, FIG. 1 is a schematic fragmentary diagram of an electric motor/generator or electric traction machine, referred to herein as electric machine 10. The electric machine 10 is configured to generate an electric machine torque by, for example, converting electrical energy into rotational motion. The electric machine 10 includes a rotor assembly 12 having a rotor shaft 14 disposed along a central axis A. The rotor assembly 12 is positioned at least partially within a stator core 16. The electric machine 10 may be a separately excited electric machine.

Electric machines generally employ a resolver to determine the rotational position and speed of the rotor relative to the stator. Furthermore, an external device is generally required for transferring power to the rotor in a separately excited electric machine. Accommodating both in an electric machine is a challenging issue. Referring to FIG. 1, the electric machine 10 includes an inductive position sensor 40 that is integrated into the structure of the electric machine 10. As described below, the electric machine 10 has an integrated structure with a position sensing capacity and wireless power transfer.

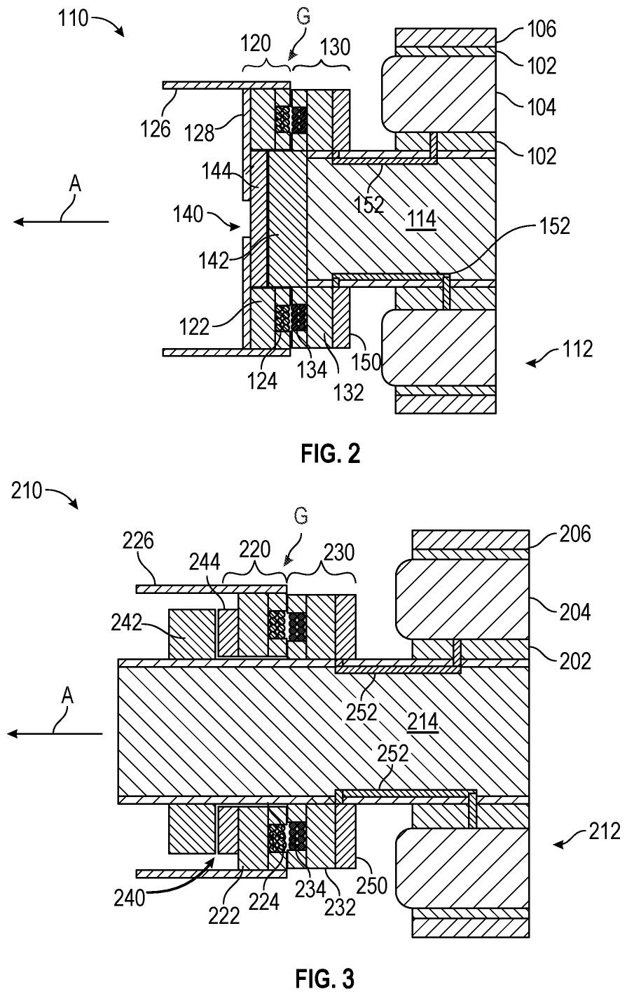

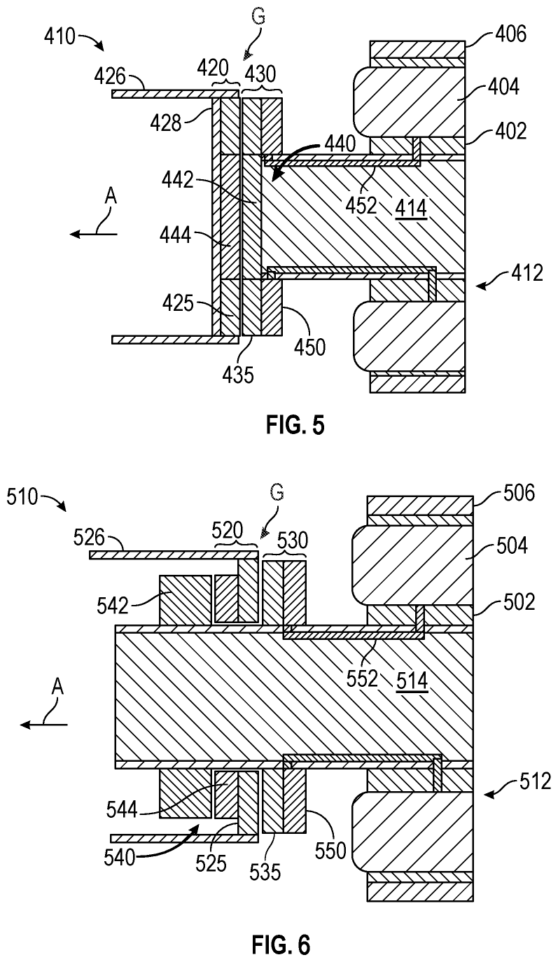

Various embodiments of the electric machine 10 are shown in and described below with respect to FIGS. 2, 3A, 3B, and 4-7. In the first, second, and third embodiments (shown in FIGS. 2, 3. 4A-4B), the electric machine utilizes an inductive power transfer mechanism, based on changes in a magnetic field. In the fourth, fifth, and sixth embodiments (shown in FIGS. 5-7), the electric machine utilizes a capacitive power transfer mechanism, based on changes in capacitance. The embodiments shown minimize the active length of the electric machine and reduce the total number of parts, thereby optimizing efficiency.

Referring to FIG. 1, the electric machine 10 may be part of a propulsion system 18 in a vehicle 20. The vehicle 20 may be a mobile platform, such as, but not limited to, a passenger car, sport utility vehicle, light truck, heavy duty vehicle, ATV, minivan, bus, transit vehicle, bicycle, robot, farm implement, sports-related equipment, boat, plane, train or other device. The vehicle 20 may take many different forms and include multiple and/or alternate components and facilities.

Referring to FIG. 1, the propulsion system 18 includes at least one energy source 22, such as a high voltage battery, and at least one inverter 24. The energy source 22 is adapted to provide direct current (DC) power to the inverter 24, which converts the direct current power into alternating current (AC) power. The electric machine 10 is configured to use the alternating current voltage from the inverter 24 to generate rotational motion subsequently transmitted to the wheels 26 of the vehicle 20. Referring to FIG. 1, the vehicle 20 includes a controller C having a processor 28 and tangible, non-transitory memory 30 on which instructions are recorded for controlling operation of the electric machine 10 based on torque demand of the vehicle 20.

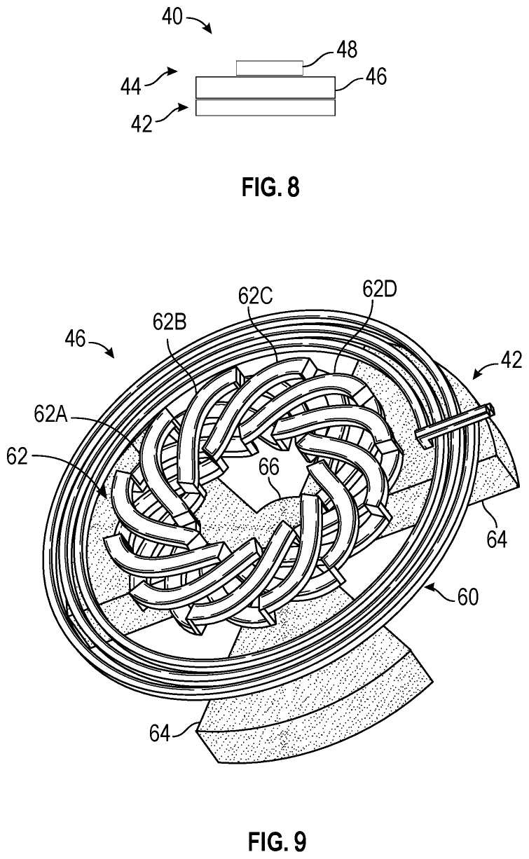

An example inductive position sensor 40 employable in the electric machine 10 of FIG. 1 is shown in FIGS. 8-9. Referring to FIG. 8, the inductive position sensor 40 includes a sensor target 42, and an inductive sensor board 44. The position of the inductive position sensor 40 within the electric machine 10 varies in each of the embodiment shown. The inductive sensor board 44 is stationary and is adapted to detect motion of the sensor target 42.

Referring to FIG. 8, the inductive sensor board 44 includes a plurality of windings 46, and a microcircuit 48. The microcircuit 48 is adapted to calculate position information of the sensor target 42. It is understood that the inductive sensor board 44 may include other components available to those skilled in the art. FIG. 9 shows the inductive position sensor 40 with the microcircuit 48 omitted. Referring to FIG. 9, the plurality of windings 46 includes a set of transmitting coils 60, and a set of receiving coils 62. The receiving coils 62 may include a positive first coil 62A, a negative first coil 62B, a positive second coil 62C, and a negative second coil 62D. The total number of receiving coils 62 is an even number that may vary based on the application at hand.

The sensor target 42 and the inductive sensor board 44 are integrated into the electric machine 10. The sensor target 42 is made of a conductive material in each of the embodiments described herein. For example, the sensor target 42 may be made of a ferrous material, such as steel. The sensor target 42 may be made of a non-ferrous material, such as aluminum and copper. In the example shown in FIG. 9, the sensor target 42 includes a plurality of spaced-apart wings 64 extending from a central base 66. The shape of the sensor target 42 may vary in each of the embodiments shown.

The inductive position sensor 40 relies on the change of induced voltage in the receiving coils 62 to determine the position of the sensor target 42, and thus the rotor shaft 14. Eddy currents flow in the target sensor 42 due to the high frequency signal in the transmitting coils 60. This results in the creation of an opposing magnetic field is created in the receiving coils 62. The net induced voltage changes in the receiving coils 62 is based on the location of the sensor target 42.

The microcircuit 48 of FIG. 8 is adapted to perform post-processing of data to translate the induced voltage measurement from the plurality of windings 46 into a tangible position signal. The microcircuit 48 may be an assembly of electronic components, such as an application-specific integrated circuit (ASIC). The microcircuit 48 may include a core embodied by a microcontroller along with a wireless communication interface and other circuitry available to those skilled in the art.

Referring now to FIG. 2, an electric machine 110 in accordance with a first embodiment is shown. The electric machine 110 includes a rotor assembly 112 having a rotor shaft 114 disposed along a central axis A. The rotor assembly 112 may include rotor poles 102, rotor windings 104, and rotor teeth 106. A stationary member 120 and a rotating member 130 are operatively connected to the rotor shaft 114. The rotating member 130 is spaced from the stationary member 120 by an air gap G.

Referring to FIG. 2, in the first embodiment, the stationary member 120 includes a stationary core 122 embedded with a first set of coils 124. The stationary member 120 may be supported or retained in position by one or more supporting structures, such as a first mount 126 and a second mount 128 from the drive unit housing. The rotating member 130 includes a rotating core 132 embedded with a second set of coils 134. The first set of coils 124 and the second set of coils 134 are conductive windings with turns.

Referring to FIG. 2, the electric machine 110 includes or is integrated with an inductive position sensor 140 having a sensor target 142 that is operatively connected to the rotor shaft 114. The sensor target 142 is fixed relative to the rotor shaft such that the sensor target 42 rotates with the rotor shaft 114. The inductive position sensor 40 includes an inductive sensor board 144 directly connected to the sensor target 142 (on-axis) along the central axis A. As in each of the embodiments herein, the inductive sensor board 144 is adapted to determine the position of the sensor target 142 and includes a plurality of windings 46 and a microcircuit 48 (see FIG. 8).

In the first embodiment of FIG. 2, the sensor target 142 is positioned directly on the rotor shaft 114 along the central axis. In other words the sensor target 142 is located on-axis, relative to the central axis A. The rotating member 130 includes a rectifier circuit 150 that is electrically coupled to the rotor windings 104 via connectors 152. In each of the embodiments described herein, the rectifier circuit 150 converts alternating current (AC) voltage to direct current (DC) voltage using a combination of electronic components, such as switches, diodes, transistors, or other components.

Referring to FIG. 2, the stationary member 120 and the rotating member 130 are configured to enable non-contact power transfer from the stationary member 120 to the rotating member 130 through the air gap G. In the first embodiment, the non-contact power transfer between the stationary member 120 and the rotating member 130 is an inductive power transfer. Alternating current (AC) may be transmitted to the stationary member 120 through one or more inverters 24 in the vehicle 20, which convert direct current provided by an energy source 22 (see FIG. 1). The AC flowing through the stationary member 120 (the first set of coils 124 embedded in the stationary core 122) results in the generation of a magnetic field that moves across the gap G to the rotating member 130 (second set of coils 134 embedded in the rotating core 122). The magnetic field results in an AC in the second set of coils 134, which is converted from AC to direct current by the rectifier circuit 150. The direct current is transmitted from the rectifier circuit 150 to the rotor windings 104, resulting in the creation of a rotor field. Interaction of the rotor field with the stator field results in the production of torque by the electric machine 110.

Referring now to FIG. 3, an electric machine 210 in accordance with a second embodiment is shown. The electric machine 210 includes a rotor assembly 212 having a rotor shaft 214 disposed along a central axis A. The rotor assembly 212 may include rotor poles 202, rotor windings 204, and rotor teeth 206. A stationary member 220 and a rotating member 230 are operatively connected to the rotor shaft 214. The rotating member 230 is spaced from the stationary member 220 by an air gap G.

In the second embodiment, the stationary member 220 includes a stationary core 222 embedded with a first set of coils 224. The stationary member 220 may be supported or retained in position by one or more supporting structures, such as a first mount 226 from the drive unit housing. Referring to FIG. 3, the rotating member 230 includes a rotating core 232 embedded with a second set of coils 234.

Referring to FIG. 3, the electric machine 210 includes an inductive position sensor 240 with a sensor target 242 made of a conductive material and an inductive sensor board 244 adapted to detect motion of the sensor target 242. The sensor target 242 is fixed relative to the rotor shaft 214 such that the sensor target 242 rotates with the rotor shaft 214.

The second embodiment of FIG. 3 is similar to the first embodiment of FIG. 2, except for the positioning of the sensor target 242 and the inductive sensor board 244. Here, the sensor target 242 and the inductive sensor board 244 are positioned circumferentially around the rotor shaft 214. In other words, the sensor target 242 and the inductive sensor board 244 are both radially external to (i.e., off-axis) relative to the central axis A. The sensor target 242 may be in direct contact with the rotor shaft 214. The inductive sensor board 244 is adjacent to the sensor target 242 along the central axis A.

The stationary member 220 and the rotating member 230 are configured to enable non-contact power transfer from the stationary member 220 to the rotating member 230 through the air gap G. Similar to the first embodiment, the non-contact power transfer between the stationary member 220 and the rotating member 230 in the second embodiment is an inductive power transfer. Alternating current (AC) flowing through the stationary member 220 (first set of coils 224 embedded in the stationary core 222) results in the generation of a magnetic field that moves across the gap G to the rotating member 230 (second set of coils 234 embedded in the rotating core 232). The magnetic field results in an alternating current in the second set of coils 234, which is converted from AC to direct current (DC) by a rectifier circuit 250. The rectifier circuit 250 may be electrically coupled to the rotor windings 204 via connectors 252.

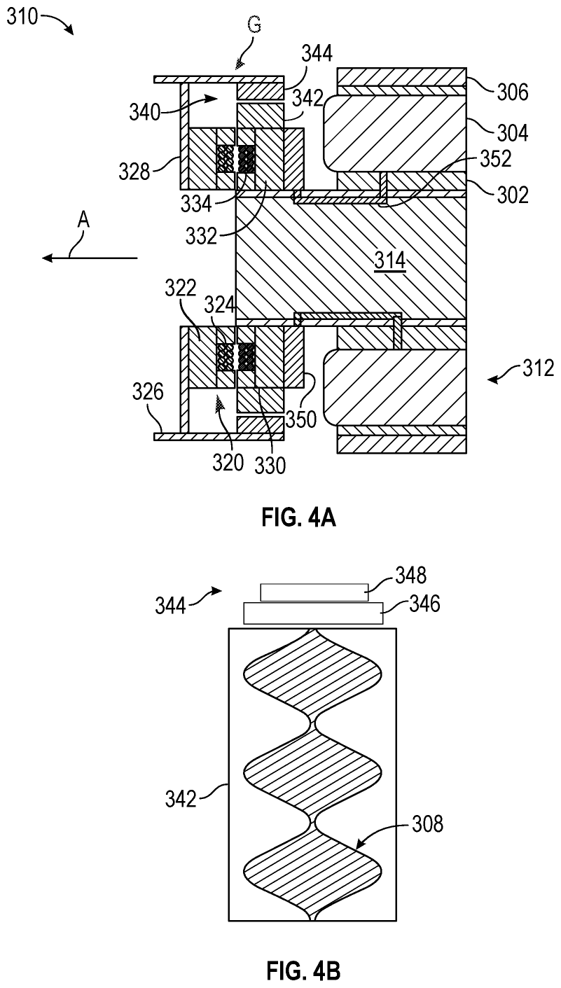

Referring now to FIGS. 4A-4B, an electric machine 310 in accordance with a third embodiment is shown. The electric machine 310 of FIG. 4A includes a rotor assembly 312 having a rotor shaft 314 along a central axis A. The rotor assembly 312 may include a rotor pole 302, rotor winding 304, and rotor teeth 306. A stationary member 320 and a rotating member 330 are operatively connected to the rotor shaft 314. The rotating member 330 is spaced from the stationary member 320 by an air gap G. The stationary member 320 includes a stationary core 322 embedded with a first set of coils 324. The stationary member 320 may be supported or retained in position by one or more supporting structures, such as a first mount 326 and a second mount 328, from the drive unit housing. Referring to FIG. 4A, the rotating member 330 includes a rotating core 332 embedded with a second set of coils 334.

Referring to FIG. 4A, the electric machine 310 includes an inductive position sensor 340 having a sensor target 342 that is operatively connected to the rotor shaft 314. The sensor target 342 is fixed relative to the rotor shaft such that the sensor target 342 rotates with the rotor shaft 314. In the example shown in FIG. 4A, the sensor target 342 is in the shape of a ring with an annular cross-section. The rotating core 322 is positioned circumferentially around the rotor shaft 314. The sensor target 342 is positioned circumferentially around the rotating core 232, such that the sensor target 342 is radially external relative to the rotor shaft 314. In some embodiments, the sensor target 342 may be etched on an exterior surface of the rotating core 322.

Referring to FIG. 4A, the inductive position sensor 340 includes an inductive sensor board 344 positioned circumferentially around or radially external to the sensor target 342. The inductive sensor board 344 is stationary relative to the rotor shaft. FIG. 4B shows a side view of the sensor target 342, showing a profile 308 of metal grooves in the sensor target 342. FIG. 4B also shows the inductive sensor board 344 with a plurality of windings 346 and a microcircuit 348.

Similar to the first and second embodiments, the rotating member 330 includes a rectifier circuit 350 for converting alternating current voltage to direct current voltage. The rectifier circuit 350 may be electrically coupled to the rotor windings 304 via connectors 352.

Referring now to FIG. 5, an electric machine 410 in accordance with a fourth embodiment is shown. The electric machine 410 includes a rotor assembly 412 having a rotor shaft 414 disposed along a central axis A. The rotor assembly 412 may include rotor poles 402, rotor windings 404, and rotor teeth 406. A stationary member 420 and a rotating member 430 are operatively connected to the rotor shaft 414. The rotating member 430 is spaced from the stationary member 420 by an air gap G. The stationary member 420 may be supported or retained in position by one or more supporting structures, such as a first mount 426 and a second mount 428, from the drive unit housing.

Referring to FIG. 5, the electric machine 410 includes an inductive position sensor 440 with a sensor target 442 made of a conductive material and an inductive sensor board 444 adapted to detect rotary motion of the sensor target 442. The sensor target 442 is fixed relative to the rotor shaft 414 such that the sensor target 442 rotates with the rotor shaft 414.

In the fourth embodiment of FIG. 5, the sensor target 442 is positioned directly (on-axis) on the rotor shaft 414 along the central axis A. The inductive sensor board 444 is adjacent (on-axis) to the sensor target 442 along the central axis A. The inductive sensor board 444 is stationary and is adapted to detect motion of the sensor target 442. It is understood that the inductive sensor board 444 may include detection and processing components available to those skilled in the art.

Referring to FIG. 5, the stationary member 420 and the rotating member 430 are configured to enable non-contact power transfer from the stationary member 420 to the rotating member 430 through the air gap G. In the fourth, fifth, and sixth embodiments, the non-contact power transfer between the stationary member 420 and the rotating member 430 is a capacitive power transfer. Referring to FIG. 5, the stationary member 420 includes a first plate 425 while the rotating member 430 includes a second plate 435. The first and second plates 425, 435 are metallic and positioned sufficiently close to one another to form a capacitor, enabling a capacitive power transfer between the stationary member 420 and the rotating member 430.

Alternating current (AC) may be transmitted to the stationary member 420 through one or more inverters 24 in the vehicle 20, which convert direct current provided by an energy source 22 (see FIG. 1). The AC results in the generation of a magnetic field that moves across the gap G. The rotating member 430 includes a rectifier circuit 450 for converting alternating current voltage to direct current voltage. The rectifier circuit 450 may be electrically coupled to the rotor windings 404 via connectors 452. The direct current is transmitted from the rectifier circuit 450 to the rotor windings 404, resulting in the creation of a rotor field. Interaction of the rotor field with the stator field results in the production of torque by the electric machine 410.

Referring now to FIG. 6, an electric machine 510 in accordance with a fifth embodiment is shown. The electric machine 510 includes a rotor assembly 512 having a rotor shaft 514 disposed along a central axis A. The rotor assembly 512 may include rotor poles 502, rotor windings 504, and rotor teeth 506. A stationary member 520 and a rotating member 530 are operatively connected to the rotor shaft 514. The rotating member 530 is spaced from the stationary member 520 by an air gap G. The stationary member 520 may be supported or retained in position by one or more supporting structures, such as a first mount 526, from the drive unit housing.

Referring to FIG. 6, the electric machine 510 includes an inductive position sensor 540 with a sensor target 542 made of a conductive material and an inductive sensor board 544 adapted to detect motion of the sensor target 542. The sensor target 542 is fixed relative to the rotor shaft 514 such that the sensor target 542 rotates with the rotor shaft 514.

Referring to FIG. 6, the stationary member 520 and the rotating member 530 are configured to permit a non-contact capacitive power transfer from the stationary member 520 to the rotating member 530 through the air gap G. The stationary member 520 includes a first plate 525 while the rotating member 530 includes a second plate 535. The first and second plates 525, 535 are metallic and positioned sufficiently close to one another to form a capacitor, enabling a capacitive power transfer between the stationary member 520 and the rotating member 530.

The fifth embodiment of FIG. 6 is similar to the fourth embodiment of FIG. 5, except for the positioning of the sensor target 542 and the inductive sensor board 544. Here, the sensor target 542 and the inductive sensor board 544 are positioned circumferentially around the rotor shaft 514. In other words, the sensor target 542 and the inductive sensor board 544 are both radially external (or off-axis) relative to the central axis A. The sensor target 542 may be in direct contact with the rotor shaft 514. The inductive sensor board 544 is adjacent to the sensor target 542 along the central axis A.

Similar to the fourth embodiment, the rotating member 530 in the fifth embodiment includes a rectifier circuit 550 for converting alternating current voltage to direct current voltage. The rectifier circuit 550 may be electrically coupled to the rotor windings 504 via connectors 552.

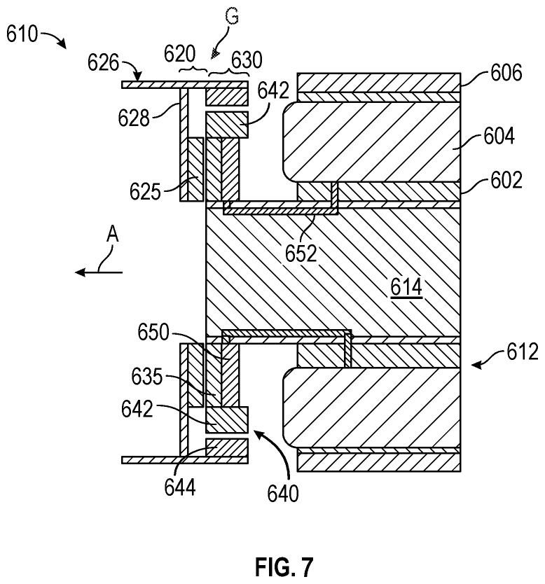

Referring now to FIG. 7, an electric machine 610 in accordance with a sixth embodiment is shown. The electric machine 610 includes a rotor assembly 612 having a rotor shaft 614 disposed along a central axis A. The rotor assembly 612 may include rotor poles 602, rotor windings 604, and rotor teeth 606. A stationary member 620 and a rotating member 630 are operatively connected to the rotor shaft 614. The rotating member 630 is spaced from the stationary member 620 by an air gap G. The stationary member 620 may be supported or retained in position by one or more supporting structures, such as a first mount 626 and a second mount 628, from the drive unit housing.

Referring to FIG. 7, the stationary member 620 includes a stationary plate 625 while the rotating member 630 includes a rotating plate 635. The plates 625, 635 are metallic and positioned sufficiently close to one another to form a capacitor, such that the non-contact power transfer between the stationary member 620 and the rotating member 630 is a capacitive power transfer. The rotating member 630 includes a rectifier circuit 650 for converting alternating current voltage to direct current voltage. The rectifier circuit 650 may be electrically coupled to the rotor windings 604 via connectors 652.

Referring to FIG. 7, the electric machine 610 includes an inductive position sensor 640 having a sensor target 642 that is operatively connected to the rotor shaft 614, and an inductive sensor board 644. The sensor target 642 is fixed relative to the rotor shaft such that the sensor target 642 rotates with the rotor shaft 614. The rotating plate 635 and the rectifier circuit 650 are positioned circumferentially around the rotor shaft 614.

In the sixth embodiment, the inductive position sensor 640 has a radial arrangement. Here, the sensor target 642 is positioned circumferentially around the rotating member 630. In other words, the sensor target 642 is radially external relative to the rotor shaft 614, the rotating plate 635 and the rectifier circuit 650. In some embodiments, the sensor target 642 may be etched on an exterior surface of the rotating plate 635. In the example shown in FIG. 7, the sensor target 642 is in the shape of a ring with an annular cross-section. The inductive sensor board 644 is positioned radially external to or circumferentially around the sensor target 642.

In summary, various embodiments of an electric machine having an integrated inductive position sensor with non-contact power transfer are disclosed. The technical advantage here is that efficiency and packaging of an inductive sensor in a non-contact power transfer apparatus is optimized.

The controller C of FIG. 1 includes a computer-readable medium (also referred to as a processor-readable medium), including a non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which may constitute a main memory. Such instructions may be transmitted by one or more transmission media, including coaxial cables, copper wire and fiber optics, including the wires that comprise a system bus coupled to a processor of a computer. Some forms of computer-readable media include, for example, a floppy disk, a flexible disk, hard disk, magnetic tape, other magnetic medium, a CD-ROM, DVD, other optical medium, a physical medium, a RAM, a PROM, an EPROM, a FLASH-EEPROM, other memory chip or cartridge, or other medium from which a computer can read.

Look-up tables, databases, data repositories or other data stores described herein may include various kinds of mechanisms for storing, accessing, and retrieving various kinds of data, including a hierarchical database, a set of files in a file storage system, an application database in a proprietary format, a relational database management system (RDBMS), etc. Each such data store may be included within a computing device employing a computer operating system such as one of those mentioned above and may be accessed via a network in one or more of a variety of manners. A file system may be accessible from a computer operating system and may include files stored in various formats. An RDBMS may employ the Structured Query Language (SQL) in addition to a language for creating, storing, editing, and executing stored procedures, such as the PL/SQL language mentioned above.

The numerical values of parameters (e.g., of quantities or conditions) in this specification, including the appended claims, are to be understood as being modified in each respective instance by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of each value and further divided ranges within the entire range. Each value within a range and the endpoints of a range are hereby disclosed as separate embodiments.

The detailed description and the drawings or FIGS. are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description, are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. An electric machine comprising:
a rotor assembly having a rotor shaft disposed along a central axis;
an inductive position sensor having a sensor target operatively connected to the rotor shaft, the sensor target being fixed relative to the rotor shaft such that the sensor target rotates with the rotor shaft;
a stationary member operatively connected to the rotor shaft;
a rotating member operatively connected to the rotor shaft, the rotating member being spaced from the stationary member by an air gap; and
wherein the stationary member and the rotating member are configured to enable non-contact power transfer from the stationary member to the rotating member through the air gap.

2. The electric machine of claim 1, wherein:
the inductive position sensor includes an inductive sensor board adapted to detect motion of the sensor target, the inductive sensor board being stationary; and
the inductive sensor board includes a plurality of windings having transmitting coils and receiving coils.

3. The electric machine of claim 2, wherein the receiving coils include a positive first coil, a negative first coil, a positive second coil, and a negative second coil.

4. The electric machine of claim 1, further comprising:
a rectifier circuit directly connected to the rotating member; and
wherein the rotor assembly includes rotor windings electrically coupled with the rectifier circuit.

5. The electric machine of claim 1, wherein the stationary member includes a stationary core embedded with a first set of coils, the rotating member including a rotating core embedded with a second set of coils, and the non-contact power transfer between the stationary member and the rotating member is an inductive power transfer.

6. The electric machine of claim 5, wherein the sensor target is positioned directly on the rotor shaft along the central axis.

7. The electric machine of claim 5, wherein the sensor target is positioned circumferentially around the rotor shaft.

8. The electric machine of claim 5, wherein the sensor target is positioned circumferentially around the rotating core, the rotating core is positioned circumferentially around the rotor shaft, and the sensor target is etched on the rotating core.

9. The electric machine of claim 1, wherein the stationary member and the rotating member respectively include a stationary plate and a rotating plate positioned sufficiently close together to form a capacitor, such that the non-contact power transfer between the stationary member and the rotating member is a capacitive power transfer.

10. The electric machine of claim 9, wherein the sensor target is positioned directly on the rotor shaft along the central axis.

11. The electric machine of claim 9, wherein the sensor target is positioned circumferentially around the rotor shaft.

12. The electric machine of claim 9, wherein the sensor target is positioned circumferentially around the rotating plate, the rotating plate is positioned circumferentially around the rotor shaft, and the sensor target is etched on the rotating plate.

13. An electric machine comprising:
a rotor assembly having a rotor shaft disposed along a central axis;
an inductive position sensor having a sensor target operatively connected to the rotor shaft, the sensor target being fixed relative to the rotor shaft such that the sensor target rotates with the rotor shaft;
a stationary member operatively connected to the rotor shaft;
a rotating member operatively connected to the rotor shaft, the rotating member being spaced from the stationary member by an air gap;
an inductive sensor board directly connected to the stationary member, the inductive sensor board being adapted to detect motion of the sensor target;
a rectifier circuit directly connected to the rotating member, the rectifier circuit being adapted to converting alternating current voltage to direct current voltage;
wherein the rotor assembly includes rotor windings electrically coupled to the rectifier circuit; and
wherein the stationary member and the rotating member are configured to enable non-contact power transfer from the stationary member to the rotating member through the air gap.

14. The electric machine of claim 13, wherein the stationary member includes a stationary core embedded with a first set of coils, the rotating member includes a rotating core embedded with a second set of coils, and the non-contact power transfer between the stationary member and the rotating member is an inductive power transfer.

15. The electric machine of claim 14, wherein the sensor target is positioned directly on the rotor shaft along the central axis.

16. The electric machine of claim 14, wherein the sensor target is positioned circumferentially around the rotating core, the rotating core is positioned circumferentially around the rotor shaft, and the sensor target is etched on the rotating core.

17. The electric machine of claim 13, wherein the stationary member and the rotating member including respective metallic plates positioned sufficiently close together to form a capacitor, such that the non-contact power transfer between the stationary member and the rotating member is a capacitive power transfer.

18. The electric machine of claim 17, wherein the sensor target is positioned directly on the rotor shaft along the central axis.

19. The electric machine of claim 17, wherein the sensor target is positioned circumferentially around the rotor shaft.

20. A vehicle comprising:
an electric machine including a rotor assembly having a rotor shaft disposed along a central axis;
an inductive position sensor having a sensor target operatively connected to the rotor shaft and an inductive sensor board adapted to detect motion of the sensor target, the sensor target being fixed relative to the rotor shaft such that the sensor target rotates with the rotor shaft;
a stationary member operatively connected to the rotor shaft, the stationary member including a stationary core embedded with a first set of coils;
a rotating member operatively connected to the rotor shaft, the rotating member being spaced from the stationary member by an air gap, the rotating member including a rotating core embedded with a second set of coils;
wherein the inductive sensor board is stationary and includes a plurality of windings having transmitting coils and receiving coils; and
wherein the stationary member and the rotating member are configured to enable non-contact power transfer from the stationary member to the rotating member through the air gap.
